(19) United States
(12) Patent Application Publication
(10) Pub. No.: US 2006/0061655 A1
(43) Pub. Date: Mar. 23, 2006

(54) Auxiliary braking light with a camera device

(76) Inventor: Chih-Yuan Wang, Taoyuan (TW)

Correspondence Address: CHIH-YUAN WANG, 235 Chung - Ho, Box 8-24, Taoyuan, TW

(21) Appl. No.: 10/946,094

(22) Filed: Sep. 22, 2004

(51) Int. Cl. H04N 7/18; H04N 9/47

(52) U.S. Cl. 348/148; 348/143

(57) ABSTRACT

A camera device is combined to an auxiliary braking light; the auxiliary braking light with a camera device is capable of being fixed to a back windshield of a car so that the camera device has a wide coverage; the auxiliary braking light is capable receiving reversing signals; and the camera device is capable of emitting image signals; the image signals from the camera device being sent to a display for monitoring images behind a car installed the auxiliary braking light.

### FIELD OF THE INVENTION

The present invention relates to an auxiliary braking light with a camera device, wherein an auxiliary braking light with a camera device is fixed on the back windshield of a car so that the auxiliary braking light with a camera device has a wide coverage for obtaining circumambience situation. Thus a driver can know the environmental situation of the car depending on images from the camera device. A display is installed in the car so that the driver can understand the situation behind the car.

### BACKGROUND OF THE INVENTION

In the prior art, the camera device for reversing a car is generally installed to a center of a protecting rod of a car or on an upper side of the car. Thereby, when the car moves backwards, the driver knows the state from the rear images captured by a camera device at a rear side of the car and a display serves to display the images to the drivers so as to avoid collisions or accidents.

However, the above mentioned prior art has the following disadvantages. The position of the camera device is too low to capture images with a wide angular coverage. Furthermore, in a dark environment, the image is vague and thus can not be identified clearly. This makes a trouble to drivers. Further the camera device is installed at a protection bar at a rear side of the car and a display serves to use with the camera device. The installation and wire arrangement are complicated. Moreover, the camera device is installed in a lower position and thus it is easy to be damaged due to a collision to the car. Besides, since the camera device is installed externally, it is easy to be thieved.

Furthermore, since the prior art auxiliary braking light is installed below the back windshield of a car, when the driver treads a brake treadle, the auxiliary braking light lights up with the rear alert lights of the car for informing other cars behind to decelerate for avoiding accident, but there are too many kinds of cars, the positions for mounting the auxiliary braking lights are important. Thereby, to select a proper position for installing a reverse car alert camera is an important object to the safety of driving.

### SUMMARY OF THE INVENTION

Accordingly, the primary object of the present invention is to provide an auxiliary braking light with a camera device, wherein the auxiliary braking light is installed to a back windshield of a car so that the camera device has a preferred coverage.

Another object of the present invention is to provide an auxiliary braking light with a camera device, wherein in one operation mode, the auxiliary braking light could have a sufficient light in a dark environment with a clear view.

Another object of the present invention is to provide an auxiliary braking light with a camera device, wherein the auxiliary braking light is fixed to a back windshield so that the installation and arrangement of the device is easy and convenient.

A further object of the present invention is to provide an auxiliary braking light with a camera device, wherein the image from the camera device can be transferred wirelessly so as to reduce the work in arrangement.

A yet object of the present invention is to provide an auxiliary braking light with a camera device, wherein the device is installed on the back windshield so as to prevent from being damaged by cars at a rear side or from being thieved.

To achieve above objects, the present invention provides an auxiliary braking light with a camera device; wherein a camera device is combined to an auxiliary braking light; the auxiliary braking light with a camera device is, capable of being fixed to a back windshield of a car so that the camera device has a wide coverage; the auxiliary braking light is capable of receiving reversing signals; and the camera device is capable of emitting image signals; the image signals from the camera device being sent to a display for monitoring images behind a car installed the auxiliary braking light.

Furthermore, in one operation mode, when the car is placed in a reverse gear, a reverse signal is sent to the camera device; then the camera device will output an image signal to the display; at this mode, the camera device is not interacted with the auxiliary braking light; the auxiliary braking light receives the braking signal so as to actuate the auxiliary braking light.

Further, in another operation mode, when the car is in a reverse gear, the camera device will output an image signal to the display; at this mode, the camera device will interact with the braking signal; then, the red light from the auxiliary braking light is helpful to the camera device; the camera device can capture images even in a dark environment.

Moreover, in a yet operation mode, when the display near a driver seat is in a condition of viewing VCD/DVD, a VCD/DVD signal will output to a controller; by the controller to output signals to the display, when the controller receives a reverse signal, the controller will stop to input VCD/DVD signal; then the capture images from the camera device is outputted to the display for displaying through the controller.

The various objects and advantages of the present invention will be more readily understood from the following detailed description when read in conjunction with the appended drawing.

### BRIEF DESCRIPTION OF THE DRAWINGS

FIG. 1 is a schematic perspective view of the auxiliary braking light with a camera device of the present invention.

FIGS. 2(a), 2(b) and 2(c) shows the operation modes and the structures of the auxiliary braking light with a camera device of the present invention.

FIGS. 3(a) and 3(b) are schematic views of the auxiliary braking light with a camera device of the present invention.

FIGS. 4(a) and 4(b) are schematic views showing the auxiliary braking light with a camera device of the present invention being installed to a travel van.

FIG. 5 is a schematic view showing the auxiliary braking light with a camera device of the present invention being installed to a

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

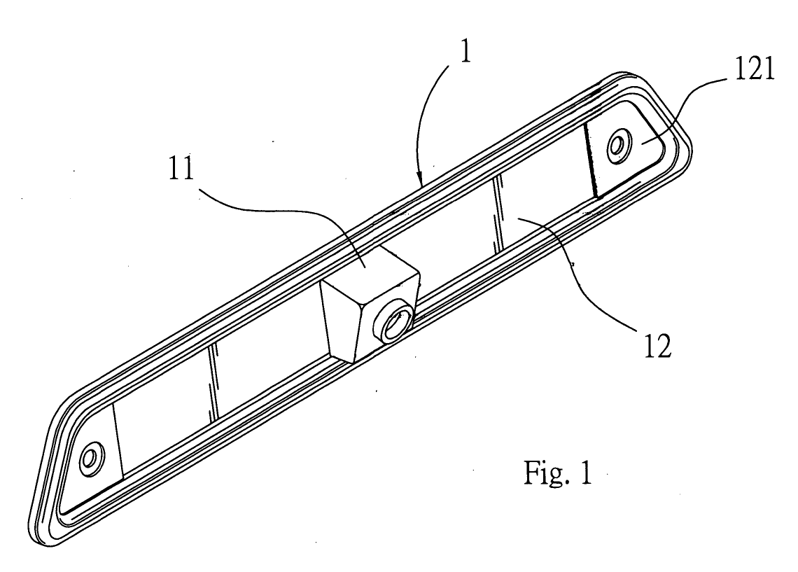

With reference to FIG. 1, a schematic perspective view of the auxiliary braking light 1 with a camera device according to the present invention is illustrated. In the present invention, a camera device 11 is combined to an auxiliary braking light 12. Two retaining portions 121 are installed to the auxiliary braking light 12. Thereby, the auxiliary braking light with a camera device can be fixed to a car easily.

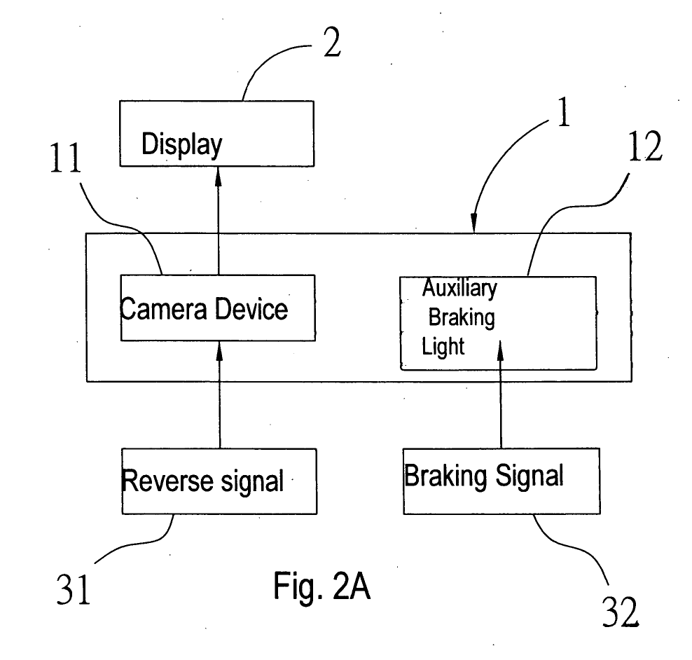

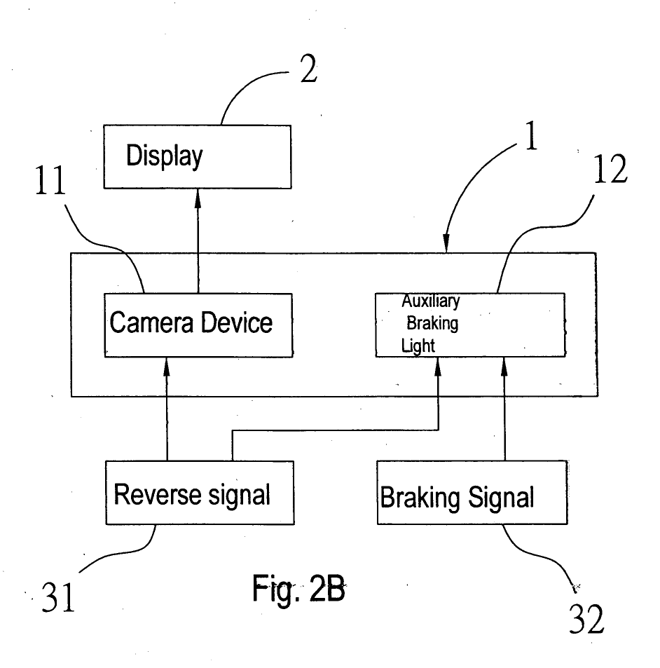

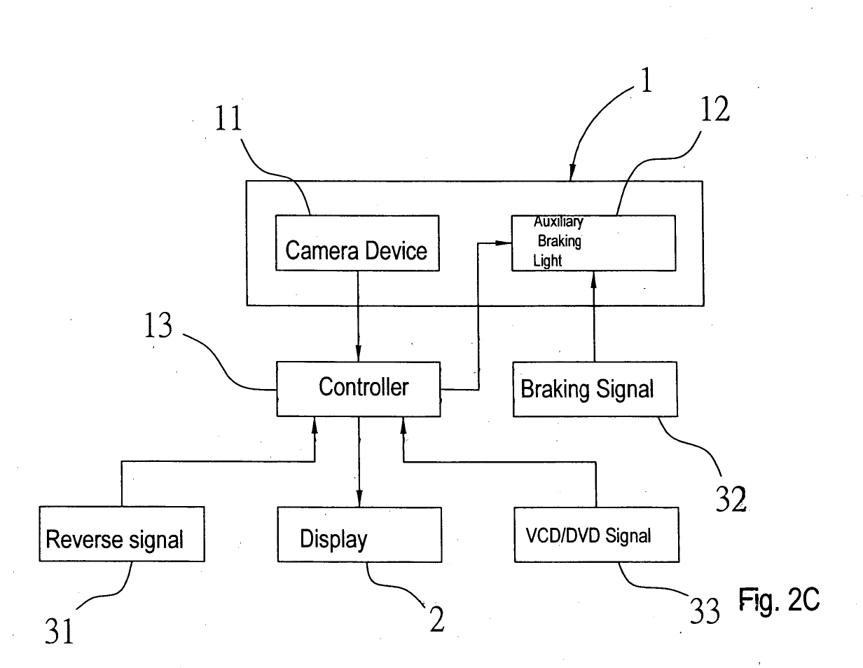

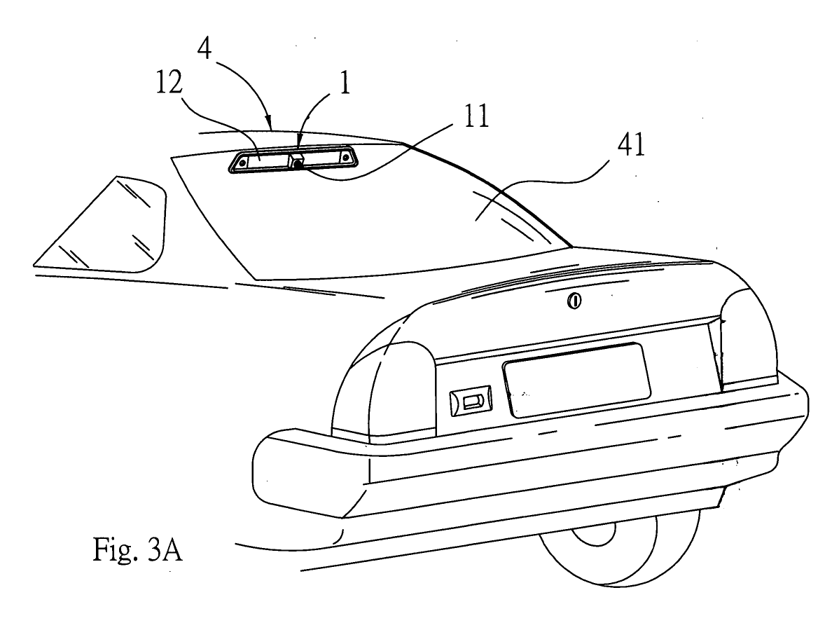

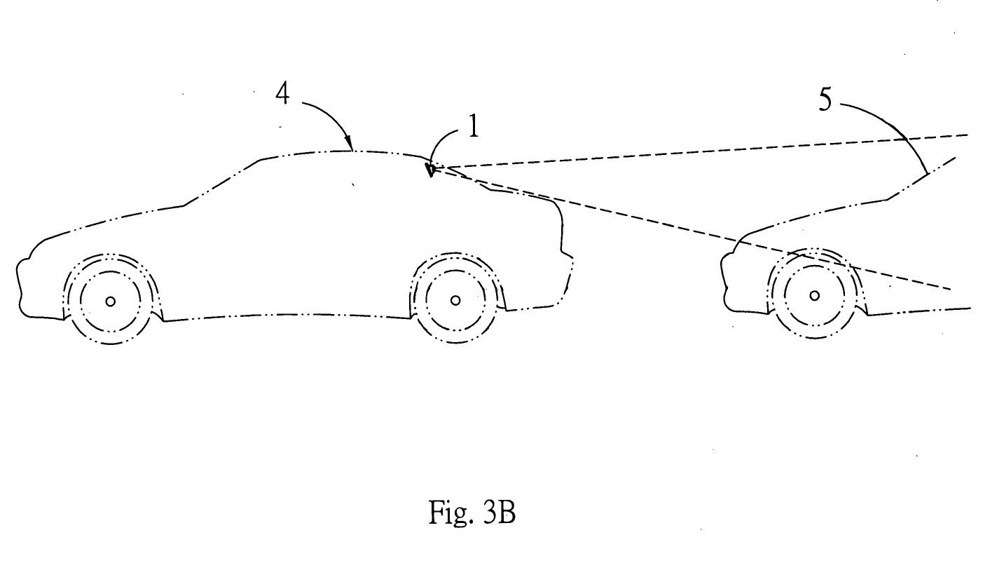

Referring to FIGS. 2(a), 2(b) and 3(c), the operation modes of the auxiliary braking light with a camera device according to the present invention is illustrated. It is known from the drawing that there are three modes in the present invention. They will be described hereinafter.

In a first operation mode, see FIG. 2(a), when the car is placed in a reverse gear (R), a reverse signal 31 is sent to the camera device 11. Then the camera device 11 will output an image signal to the display 2. At this mode, the camera device 11 is not interacted with the auxiliary braking light 12. The auxiliary braking light 12 receives the braking signal 32 so as to actuate the auxiliary braking light 12.

In the second operation mode, see FIG. 2(b), when the car is in a reverse gear (R), the camera device 11 will output an image signal to the display 2. At this mode, the camera device 11 will interact with the braking signal 32. Then, the red light from the auxiliary braking light 12 is helpful to the camera device 11. The camera device 11 can capture images even in a dark environment.

In the third operation mode, as shown in FIG. 2(c), when the display 2 near a driver seat is in a condition of viewing VCD/DVD, a VCD/DVD signal 33 will output to a controller 13. By the controller 13 to output signals to the display 2, when the controller 13 receives a reverse signal 31, the controller 13 will stop to input VCD/DVD signals 33. Then the captured images from the camera device 11 are outputted to the display 2 for displaying through the controller 13. Then the auxiliary braking light 12 acts according to the first mode or the second mode.

The transmission in above operation modes can be completed by wireless or wired way.

Referring to FIGS. 3(a) and 3(b), a schematic view showing that the auxiliary braking light with a camera device of the present invention is installed to a car. In the drawing, the auxiliary braking light with a camera device 1 of the present invention is installed to a back windshield 41 of a car 4. The camera device 11 can have a preferred capturing angle and the car at the rear side can clearly see the auxiliary braking light 12 in a higher position so as to inform the rear car 5 to decelerate to avoid accident to occur.

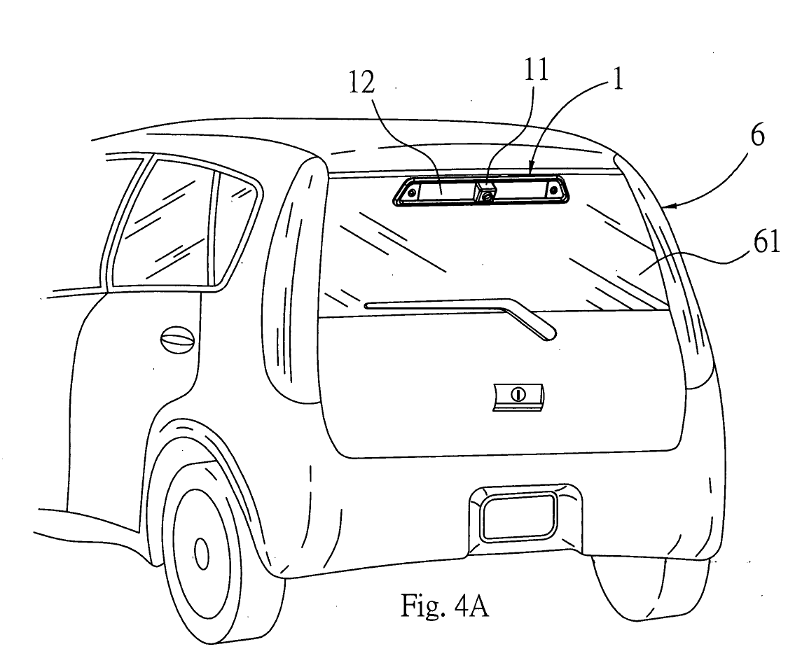

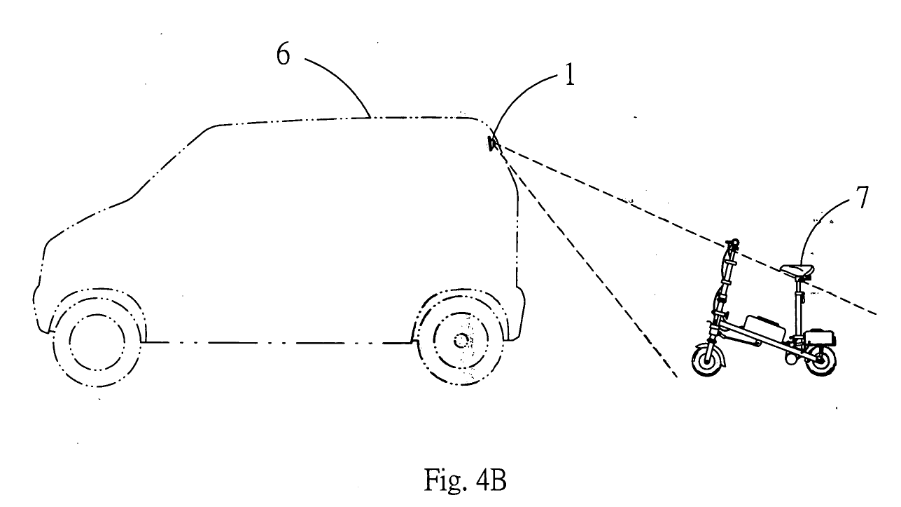

With reference to FIGS. 4(a) and 4(b), a schematic view showing that the auxiliary braking light with a camera device of the present invention is installed at a travel van. It is known from the drawing that the auxiliary braking light with a camera device 1 of the present invention is fixed to a back windshield 61 of a travel van 6 so that the camera device 11 has a larger image capturing coverage. The dead angles are reduced. Thereby, the driving state of a bicycle 7 behind the car can be viewed clearly so as to avoid an accident. Since the auxiliary braking light 12 is installed at a higher position, the drivers of the rear cars can view the state clearly so as to decelerate.

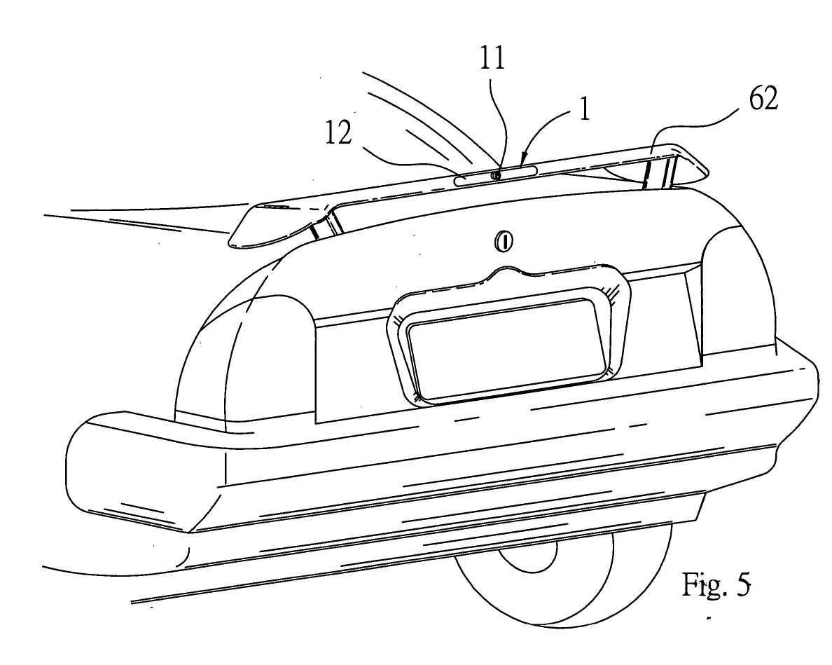

With reference to FIG. 5, it is illustrated that the auxiliary braking light with a camera device of the present invention is installed to a tail wing of a car. It is known from the drawing that the present invention is installed to a tail wing 62 of a car. Likewise, the camera device 11 has a wide coverage so that the driver can know the state of the car behind so as to prevent from accident. Since the auxiliary braking light 12 is installed highly, so that the state of car behind can know clearly to inform the car behind to decelerate.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An auxiliary braking light with a camera device; wherein a camera device is combined to an auxiliary braking light; the auxiliary braking light with a camera device is capable of being fixed to a back windshield of a car so that the camera device has a wide coverage; the auxiliary braking light is capable of receiving reversing signals; and the camera device is capable of emitting image signals; the image signals from the camera device being sent to a display for monitoring images behind a car which is installed the auxiliary braking light.

2. The auxiliary braking light with a camera device as claimed in claim 1, wherein two retaining portions are installed to the auxiliary braking light.

3. The auxiliary braking light with a camera device as claimed in claim 1, wherein in one operation mode,- when the car is situated in a reverse gear state, a reverse signal is sent to the camera device; then the camera device will output an image signal to the display; at this mode, the camera device is not interacted with the auxiliary braking light; the auxiliary braking light receives the braking signal to actuate the auxiliary braking light.

4. The auxiliary braking light with a camera device as claimed in claim 1, wherein in one operation mode, when the car is situated in a reverse gear state, the camera device will output an image signal to the display; at this mode, the camera device will interact with the braking signal; then, an alert light from the auxiliary braking light is helpful to the camera device to capturing images; the camera device can capture images even in a dark environment.

5. The auxiliary braking light with a camera device as claimed in claim 1, wherein in one operation mode, when the display near a driver seat is in a condition of viewing VCD/DVD, a VCD/DVD signal will output to a controller; by the controller to output signals to the display, when the controller receives a reverse signal, the controller will stop to input VCD/DVD signal; then the capture images from the camera device is outputted to the display for displaying through the controller.

6. The auxiliary braking light with a camera device as claimed in claim 1, wherein transmission of signals are performed by one of a wired way and a wireless way.
